(19) United States
(12) Patent Application Publication
(10) Pub. No.: US 2010/0230871 A1
(43) Pub. Date: Sep. 16, 2010

(54) Method of Sintering Ceramic Materials

(75) Inventors: Gary John Wright, Derby (GB); Nigel Thomas Hart, Singapore (SG); Michael Bernhard Jorger, Derby (GB); Gerard Daniel Agnew, Derby (GB)

Correspondence Address: OLIFF & BERRIDGE, PLC, P.O. BOX 320850, ALEXANDRIA, VA, 22320-4850, US

(73) Assignee: ROLLS-ROYCE FUEL CELL SYSTEMS LIMITED, DERBY (GB)

(21) Appl. No.: 12/223,265

(22) PCT Filed: Feb. 20, 2007
(86) PCT No.: PCT/GB2007/000573

§ 371 Date: Jan. 15, 2009

(30) Foreign Application Priority Data
Mar. 24, 2006 (GB) 0605907.5

(51) Int. Cl. C04B 35/64

(52) U.S. Cl. 264/666

(57) ABSTRACT

A method of sintering a ceramic material comprises increasing the temperature of the ceramic material to a first predetermined temperature and maintaining the temperature of the ceramic material at the first predetermined temperature for a predetermined time period to increase the grain size of the ceramic material. Increasing the temperature of the ceramic material to a second predetermined temperature, decreasing the temperature of the ceramic material to a third predetermined temperature to freeze the grain size of the ceramic material and maintaining the temperature of the ceramic material at the third predetermined temperature for a third predetermined time period to densify the ceramic material. Finally decreasing the temperature of the ceramic material to ambient temperature. The method increases the density of the ceramic material. Used for electrolyte layers of solid oxide fuel cells.

The present invention relates to sintering of ceramic materials, in particular for sintering ceramic materials for solid oxide fuel cell components or ceramic materials for gas turbine engine components and more particularly for ceramic coatings on gas turbine engine components or ceramic layers in solid oxide fuel cell components.

In a conventional process for sintering ceramic materials the temperature of a ceramic powder is increased at a predetermined rate and then the temperature is held constant at the maximum temperature until maximum density is achieved. The grain size of the ceramic material increases continuously with the density. This sintering process comprises three stages. A first stage, prior to sintering, in which an organic binder is burned out of the ceramic material and gaseous products of decomposition and oxidation are eliminated from the ceramic material. A second stage, sintering, in which the ceramic material is sintered at elevated temperature, greater than half the melting point of the ceramic material, for a predetermined time to produce a dense ceramic body. A third stage, post sintering, in which the ceramic material is cooled to ambient temperature and this step may include thermal and chemical annealing.

A relatively high rate of increase of temperature reduces grain coarsening of the ceramic material. The isothermal hold at the maximum temperature reduces the porosity and the grains of the ceramic material grow. As the grains grow the strength of the ceramic body becomes weaker and thus is less tolerant to stresses from changes in temperature and environment. As the grains grow and become equal in thickness to the thickness of the sintered layer the driving force for densification is greatly reduced and therefore the driving force for grain growth decreases with increasing grain size. The cooling rate is selected to produce a ceramic body without damage.

There are two different types of sintering, constrained sintering and unconstrained sintering. In unconstrained sintering the ceramic grains are free to move in all directions equally, i.e. in mutually perpendicular x, y and z directions. In constrained sintering the ceramic grains are constrained by a fixed substrate and the ceramic grains are free to move in only one direction, i.e. the x and y directions are fixed and movement only in the z direction. The different sintering types produce different sizes of interstices between the ceramic grains, e.g. the unconstrained sintering produces smaller interstices between the ceramic grains.

Thus, the sintering of ceramic layers, or ceramic coatings, on other components suffers from an inability to provide adequate density for the ceramic layers or ceramic coatings.

Accordingly the present invention seeks to provide a novel method of sintering a ceramic material that reduces, preferably overcomes, the above- mentioned problem.

Accordingly the present invention provides a method of sintering a ceramic material comprising the steps of
a) increasing the temperature of the ceramic material to a first predetermined temperature,
b) maintaining the temperature of the ceramic material at the first predetermined temperature for a first predetermined time period to increase the grain size of the ceramic material,
c) increasing the temperature of the ceramic material to a second predetermined temperature, wherein the second predetermined temperature is greater than the first predetermined temperature,
d) decreasing the temperature of the ceramic material to a third predetermined temperature to freeze the grain size of the ceramic material,
e) maintaining the temperature of the ceramic material at the third predetermined temperature for a third predetermined time period to densify the ceramic material, and
f) decreasing the temperature of the ceramic material to ambient temperature.

Preferably step a) increases the temperature of the ceramic material at a rate between 0.1° C. min⁻¹ and 20° C. min⁻¹.

Preferably step c) increases the temperature of the ceramic material at a rate between 0.1° C. min⁻¹ and 20° C. min⁻¹.

The ceramic material may comprise alumina, step a) comprises increasing the temperature of the alumina to a first predetermined temperature of 1080° C., step b) comprises maintaining the temperature of the alumina at the first predetermined temperature of 1080° C. for a first predetermined time period of 4 hours to increase the grain size of the alumina, step c) comprises increasing the temperature of the alumina to a second predetermined temperature of 1750° C., step d) comprises decreasing the temperature of the alumina to a third predetermined temperature of 1550° C. to freeze the grain size of the alumina, step e) comprises maintaining the temperature of the alumina at the third predetermined temperature of 1550° C. for a third predetermined time period of 8 hours to densify the alumina and step f) comprises decreasing the temperature of the alumina to ambient temperature.

Preferably step a) increases the temperature at a rate of 20° C. min⁻¹.

Preferably step a) includes a preliminary increase in temperature to burn out organic binder and remove gaseous products.

Preferably step c) increases the temperature at a rate of 20° C. min⁻¹.

Preferably step d) decreases the temperature at a rate of 40° C. min⁻¹ over time period t₄.

Preferably step f) decreases the temperature at a rate of 20° C. min⁻¹.

The ceramic material may comprise zirconia, step a) increases the temperature of the zirconia to a first predetermined temperature of 950° C. to 1200° C., step b) maintains the temperature of the zirconia at the first predetermined temperature of 950° C. to 1200° C. for a first predetermined time period of 4 to 20 hours to increase the grain size of the zirconia, step c) increases the temperature of the zirconia to a second predetermined temperature of 1200° C. to 1600° C., step d) decreases the temperature of the zirconia to a third predetermined temperature of 1000° C. to 1500° C. to freeze the grain size of the zirconia, step e) maintains the temperature of the zirconia at the third predetermined temperature of 1000° C. to 1500° C. for a third predetermined time period of 4 to 20 hours to densify the zirconia, step f) decreases the temperature of the zirconia to ambient temperature.

Preferably step a) increases the temperature at a rate of 1° C. min⁻¹ to 20° C. min⁻¹.

Preferably step a) includes a preliminary increase in temperature to burn out organic binder and remove gaseous products.

Preferably step c) increases the temperature at a rate of 1° C. min⁻¹ to 20° C. min⁻¹.

Preferably step d) decreases the temperature at a rate of 40° C. min⁻¹.

Preferably step f) decreases the temperature at a rate of 1° C. min⁻¹ to 20° C. min⁻¹.

Preferably a solid oxide fuel cell has a ceramic material sintered according to the method of the present invention. Preferably the ceramic material is a ceramic layer of the solid oxide fuel cell. Preferably the ceramic layer is an electrolyte layer of the solid oxide fuel cell.

Alternatively a gas turbine engine component has a ceramic material sintered according to the method of the present invention. The ceramic material may be a ceramic coating on the gas turbine engine component. The gas turbine engine component may be a turbine blade, a turbine vane or a combustion chamber.

The present invention will be more fully described by way of example with reference to the accompanying drawings in which:

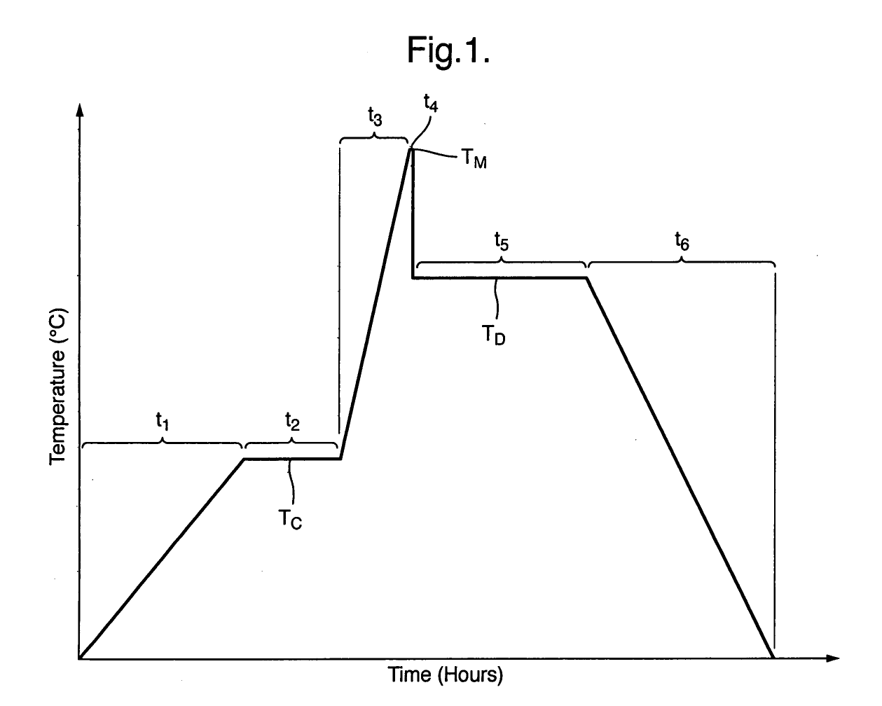

FIG. 1 shows a graph of temperature against time for a method of sintering ceramic materials according to the present invention.

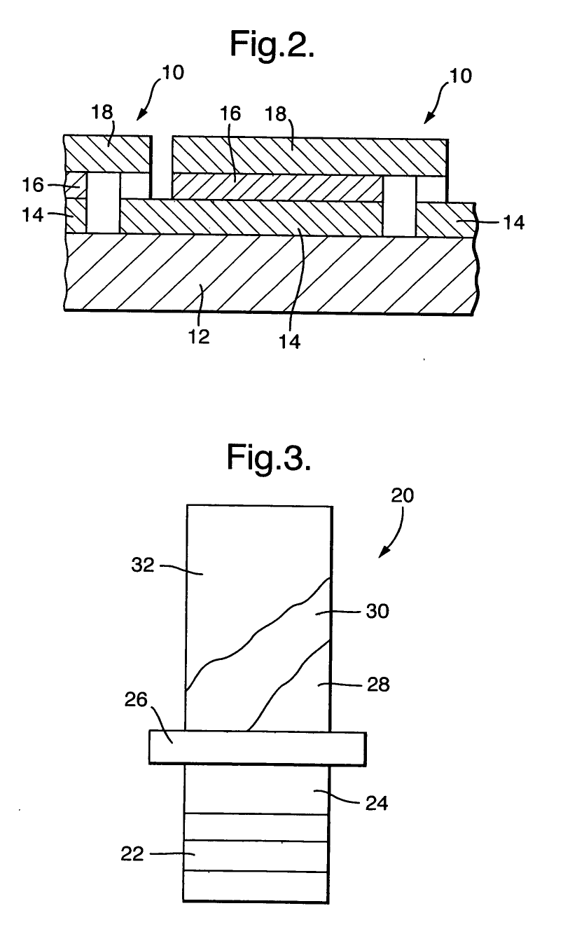

FIG. 2 shows a solid oxide fuel cell with a ceramic material sintered according to the present invention.

FIG. 3 shows a gas turbine engine turbine blade with a ceramic material sintered according to the present invention.

A method of sintering ceramic materials according to the present invention, as illustrated in FIG. 1, comprises sequentially the steps of coarsening, freezing and densifying the ceramic grains, or ceramic particles. The coarsening step enlarges, or increases, the grain size of the ceramic grains and redistributes the pores, or interstices, between the ceramic grains to produce a redistributed pore network in the ceramic material. The coarsening step allows the subsequent steps to be effective for constrained sintering. The freezing step takes the redistributed pore network in the ceramic material to a maximum temperature as rapidly as possible without causing fracture of the ceramic material followed by a rapid decrease in temperature. This freezes the microstructure of the ceramic material and prevents the growth of the grains normally associated with conventional sintering. The densifying step uses a dwell at a predetermined temperature to reduce the size of the pores, or interstices and thus increase the density of the ceramic material.

In more detail the method of sintering the ceramic material comprises a first step, which increases the temperature of the ceramic material over time period t₁ to a first predetermined temperature T_{C}. The first step generally increases the temperature at a rate between 0.1° C. min⁻¹ and 20° C. min⁻¹ and this may include a preliminary increase in temperature to burn out organic binder and remove gaseous products. A second step maintains the temperature of the ceramic material at the first predetermined temperature T_{C} for a first predetermined time period t₂ to increase the grain size of the ceramic material. The first predetermined time period is purely dependent on the properties of the ceramic material. A third step increases the temperature of the ceramic material over a time period t₃ to a second predetermined maximum temperature T_{M}, wherein the second predetermined maximum temperature T_{M} is greater than the first predetermined temperature T_{C}. The third step generally increases the temperature at a rate between 0.1° C. min⁻¹ and 20° C. min⁻¹. A fourth step decreases the temperature of the ceramic material over time period t₄ to a third predetermined temperature T_{D} to freeze the grain size of the ceramic material. Ideally the time period t₄ is zero. However, the time period t₄ is as small as practically possible and is determined by the sintering equipment employed. A fifth step maintains the temperature of the ceramic material at the third predetermined temperature T_{D} for a third predetermined time period t₅ to densify the ceramic material. The third predetermined time period is purely dependent on the properties of the ceramic material. A sixth step decreases the temperature of the ceramic material over time period t₆ to ambient temperature. The cooling rate for the ceramic material is determined by the ceramic materials tolerance to thermal shock, i.e. the ceramic material must be cooled at a rate such that the ceramic material is not damaged due to cracking etc.

### EXAMPLE 1

As an example for sintering alumina, a first step increases the temperature of the alumina over time period t₁ to a first predetermined temperature T_{C} of 1080° C. The first step generally increases the temperature at a rate of 20° C. min⁻¹ and this may include a preliminary increase in temperature to burn out organic binder and remove gaseous products. A second step maintains the temperature of the alumina at the first predetermined temperature T_{C}, of 1080° C., for a first predetermined time period t₂, of 4 hours, to increase the grain size of the alumina. A third step increases the temperature of the alumina over a time period t₃ to a second predetermined maximum temperature T_{M}, of 1750° C., wherein the second predetermined maximum temperature T_{M}, 1750° C., is greater than the first predetermined temperature T_{C}, 1080° C. The third step generally increases the temperature at a rate of 20° C. min⁻¹. A fourth step decreases the temperature of the alumina over time period t₄ to a third predetermined temperature T_{D}, 1550° C., to freeze the grain size of the alumina. The temperature is decreased at a rate of 40° C. min⁻¹ over time period t₄. A fifth step maintains the temperature of the alumina at the third predetermined temperature T_{D}, 1550° C., for a third predetermined time period t₅, 8 hours, to densify the alumina. A sixth step decreases the temperature of the alumina over time period t₆ to ambient temperature. The cooling rate for the alumina is 20° C. min⁻¹ such that the alumina is not damaged due to cracking etc.

### EXAMPLE 2

As an example for sintering yttria stabilised zirconia, a first step increases the temperature of the zirconia over time period t₁ to a first predetermined temperature T_{C} of 950° C. to 1200° C. The first step generally increases the temperature at a rate of 1° C. min⁻¹ to 20° C. min⁻¹ and this may include a preliminary increase in temperature to burn out organic binder and remove gaseous products. A second step maintains the temperature of the zirconia at the first predetermined temperature T_{C}, of 950° C. to 1200° C., for a first predetermined time period t₂, of 4 to 20 hours, to increase the grain size of the zirconia. A third step increases the temperature of the zirconia over a time period t₃ to a second predetermined maximum temperature T_{M}, of 1200° C. to 1600° C., wherein the second predetermined maximum temperature T_{M}, 1200° C. to 1600° C., is greater than the first predetermined temperature T_{C}, 950° C. to 1200° C. The third step generally increases the temperature at a rate of 1° C. min⁻¹ to 20° C. min⁻¹. A fourth step decreases the temperature of the zirconia over time period t₄ to a third predetermined temperature T_{D}, 1000° C. to 1500° C., to freeze the grain size of the zirconia. The temperature is decreased at a rate of 40° C. min⁻¹ over time period t₄. A fifth step maintains the temperature of the zirconia at the third predetermined temperature T_{D}, 1000° C. to 1500° C., for a third predetermined time period t₅, 4 to 20 hours, to densify the zirconia. A sixth step decreases the temperature of the zirconia over time period t₆ to ambient temperature. The cooling rate for the zirconia is 1° C. min⁻¹ to 20° C. min⁻¹ such that the zirconia is not damaged due to cracking etc.

A solid oxide fuel cell 10, as shown in FIG. 2, is arranged on a porous substrate 12. The solid oxide fuel cell 10 comprises an anode electrode 14 arranged on the porous substrate 12, an electrolyte 16 arranged on the anode electrode 14 and a cathode electrode 18 arranged on the electrolyte 16. The anode electrode 14, the electrolyte 16 and the cathode electrode 18 comprise layers of ceramic materials sequentially deposited on the porous substrate 12. The electrolyte 16 has been sintered according to the present invention to produce a dense gas tight ceramic layer. The electrolyte 16 comprises for example zirconia, yttria-stabilised zirconia, doped ceria or lanthanum strontium gallium magnesium oxide (LSGM).

A gas turbine engine turbine blade 20, as shown in FIG. 3, comprises a root portion 22, a shank portion 24, a platform portion 26 and an aerofoil portion 28. The aerofoil portion 28 has a thermal barrier coating system comprising a bond coating 30 on the aerofoil portion 28 and a ceramic coating 32 on the bond coating 30. The ceramic coating 32 has been sintered according to the present invention to produce a dense ceramic coating 32. The ceramic coating 32 comprises for example zirconia, yttria stabilised zirconia or other suitable ceramic.

The present invention is also applicable to piezo-electric components for example comprising barium titanate (BaTiO₃). The present invention is also applicable to magnetic components for example comprising iron-copper-nickel ferrite (Fe—Cu—Ni-ferrite).

The advantage of the present invention is that the coarsening provides a homogeneous distribution of small pores, interstices, in the ceramic material and the grains of the ceramic material have been coarsened allowing the small pores, interstices, which are smaller than the ceramic grains to shrink at a relatively fast rate during freezing and densifying. The densifying maintains the ceramic material at a predetermined temperature, such that the pores, interstices, between the ceramic grains are reduced in size, thus homogenising the pore structure of the ceramic material increasing the density of the ceramic material.

The sintering process of the present invention may be used to sinter ceramic layers of solid oxide fuel cells, for example the electrolyte layer. The electrolyte layer of a solid oxide fuel cell is required to be a physical barrier between a gaseous fuel on an anode side of the electrolyte layer and a gaseous oxidant on a cathode side of the electrolyte layer. Any gaseous leak path through the electrolyte layer will allow fuel and oxidant to come into contact. This will cause a reduction in solid oxide fuel cell performance in terms of fuel utilisation and could be detrimental to the mechanical integrity and durability of the solid oxide fuel cell structure.

The sintering process of the present invention provides reduced porosity of the ceramic material in the electrolyte layer and therefore reduces the risk of gaseous fuel leakage through the electrolyte layer from the anode side to the cathode side of the electrolyte layer. In addition the ceramic material of the electrolyte layer has smaller grain size and has reduced stress and strain.

Thus the present invention has the ability to provide a dense microstructure in a layer, film or coating of ceramic material, which has been deposited onto a pre-existing layer, substrate or component with a reduced risk of defects, such as cracks and large pores, being present in the final sintered layer, film or coating of ceramic material.

The present invention is also applicable to ceramic coatings applied to gas turbine engine components, for example turbine blades, turbine vanes, combustion chambers etc.

1. A method of sintering a ceramic material comprising the steps of
a) increasing the temperature of the ceramic material to a first predetermined temperature,
b) maintaining the temperature of the ceramic material at the first predetermined temperature for a first predetermined time period increase the grain size of the ceramic material,
c) increasing the temperature of the ceramic material to a second predetermined temperature, wherein the second predetermined temperature is greater than the first predetermined temperature,
d) decreasing the temperature of the ceramic material to a third predetermined temperature to freeze the grain size of the ceramic material,
e) maintaining the temperature of the ceramic material at the third predetermined temperature for a third predetermined time period to densify the ceramic material, and
f) decreasing the temperature of the ceramic material to ambient temperature.

2. A method as claimed in claim 1 wherein step a) increases the temperature of the ceramic material at a rate between 0.1° C. min⁻¹ and 20° C. min⁻¹.

3. A method as claimed in claim 1 wherein step c) increases the temperature of the ceramic material at a rate between 0.1° C. min⁻¹ and 20° C. min⁻¹.

4. A method as claimed in claim 1 wherein the ceramic material comprises alumina, step a) comprises increasing the temperature of the alumina to a first predetermined temperature of 1080° C., step b) comprises maintaining the temperature of the alumina at the first predetermined temperature of 1080° C. for a first predetermined time period of 4 hours to increase the grain size of the alumina, step c) comprises increasing the temperature of the alumina to a second predetermined temperature of 1750° C., step d) comprises decreasing the temperature of the alumina to a third predetermined temperature of 1550° C. to freeze the grain size of the alumina, step e) comprises maintaining the temperature of the alumina at the third predetermined temperature of 1550° C. for a third predetermined time period of 8 hours to densify the alumina and step f) comprises decreasing the temperature of the alumina to ambient temperature.

5. A method as claimed in claim 4 wherein step a) increases the temperature at a rate of 20° C. min⁻¹.

6. A method as claimed in claim 4 wherein step a) includes a preliminary increase in temperature to burn out organic binder and remove gaseous products.

7. A method as claimed in claim 4, wherein step c) increases the temperature at a rate of 20° C. min⁻¹.

8. A method as claimed in claim 4, wherein step d) decreases the temperature at a rate of 40° C. min⁻¹.

9. A method as claimed in claim 4, wherein step f) decreases the temperature at a rate of 20° C. min⁻¹.

10. A method as claimed in claim 1 wherein the ceramic material comprises zirconia, step a) increases the temperature of the zirconia to a first predetermined temperature of 950° C. to 1200° C., step b) maintains the temperature of the zirconia at the first predetermined temperature of 950° C. to 1200° C. for a first predetermined time period of 4 to 20 hours to increase the grain size of the zirconia, step c) increases the temperature of the zirconia to a second predetermined temperature of 1200° C. to 1600° C., step d) decreases the temperature of the zirconia to a third predetermined temperature of 1000° C. to 1500° C. to freeze the grain size of the zirconia, step e) maintains the temperature of the zirconia at the third predetermined temperature of 1000° C. to 1500° C. for a third predetermined time period of 4 to 20 hours to densify the zirconia, step f) decreases the temperature of the zirconia to ambient temperature.

11. A method as claimed in claim 10 wherein step a) increases the temperature at a rate of 1° C. min−1 to 20° C. min⁻¹.

12. A method as claimed in claim 10 wherein step a) includes a preliminary increase in temperature to burn out organic binder and remove gaseous products.

13. A method as claimed in claim 10, wherein step c) increases the temperature at a rate of 1° C. min⁻¹ to 20° C. min⁻¹.

14. A method as claimed in claim 10, wherein step d) decreases the temperature at a rate of 40° C. min⁻¹.

15. A method as claimed in claim 10, wherein step f) decreases the temperature at a rate of 1° C. min⁻¹ to 20° C. min⁻¹.

16. A method as claimed in claim 1 wherein the ceramic material is ceramic coating on a gas turbine engine component.

17. A method as claimed in claim 16 wherein the gas turbine engine component is a turbine blade, a turbine vane or a combustion chamber.

18. A method as claimed in claim 1 wherein the ceramic material is a ceramic layer of a solid oxide fuel cell.

19. A method as claimed in claim 18 wherein the ceramic layer is an electrolyte layer of the solid oxide fuel cell.
